(19) United States
(12) Patent Application Publication
(10) Pub. No.: US 2026/0369172 A1
(43) Pub. Date: Nov. 19, 2026

(54) METHOD AND SYSTEM FOR ASSISTING IN MANAGING THE TAXIING OF AT LEAST ONE AIRCRAFT AT AN AIRPORT

(71) Applicant: Airbus Operations SAS, TOULOUSE (FR)

(72) Inventor: Benjamin THUBERT, TOULOUSE (FR)

(21) Appl. No.: 19/678,409

(22) Filed: May 15, 2026

(30) Foreign Application Priority Data
May 19, 2025 (FR) FR2505334

(51) Int. Cl. G08G 5/51; G08G 5/26; G08G 5/59; G08G 5/72

(52) U.S. Cl. CPC G08G 5/51; G08G 5/26; G08G 5/59; G08G 5/727

(57) ABSTRACT

In an airport traffic management method, input data is acquired. A schedule that deterministically assigns a route for each of the aircraft is generated. The route of each aircraft defines associations between predetermined transit zones and predetermined time slots. The current position of the aircraft that are operating at the airport is tracked, an authorization to taxi if the transit zone directly after the transit zone in which the aircraft in question is currently situated is available is generated. Each authorization is transmitted to the aircraft for which it was generated. The steps are carried out continuously and automatically, which allows an economic gain, in particular by reducing the fuel consumption of the aircraft.

### CROSS-REFERENCES TO RELATED APPLICATIONS

This application claims the benefit of French Patent Application Number FR2505334, filed on May 19, 2025, the entire disclosure of which is incorporated herein by way of reference.

### FIELD OF THE INVENTION

The present invention relates to a method and system for assisting in managing the taxiing of at least one aircraft at an airport.

### BACKGROUND OF THE INVENTION

Managing the taxiing of aircraft, for example passenger aircraft, at an airport presents significant economic and security challenges. Between the time an aircraft arrives at an airport and the time it leaves said airport, the aircraft must perform a series of ground operations involving taxiing on taxiways at the airport.

Generally, an aircraft's ground operations at an airport include taxiing on taxiways from a landing runway to an airport terminal and/or to a parking bay and then to a take-off runway. These ground operations represent a cost related to aircraft fuel consumption and require precise and robust management to avoid any incidents on the taxiways.

The taxiing of aircraft at an airport is generally managed from a control tower by controllers who receive information from the aircraft and from airport systems. Based on this information, controllers provide each of the aircraft operating at the airport with an authorization to taxi to their next transit point at the airport. Until the aircraft have received an authorization, they cannot taxi to the next transit point.

However, this management method is not completely satisfactory. This is because aircraft taxiing is managed progressively, which does not allow aircraft traffic streams at the airport to be optimized. As a result, aircraft sometimes have to take a route that is not necessarily optimum in terms of distance and/or journey time, leading to additional fuel consumption that could be avoided.

The management of aircraft taxiing at an airport could therefore be improved.

### SUMMARY OF THE INVENTION

The aim of the present invention is to overcome the aforementioned drawbacks. The invention relates to an airport traffic management method for assisting in managing the taxiing of at least one aircraft at an airport.

According to the invention, the method comprises at least the following sequence of steps, performed continuously and automatically:
an acquisition step, performed by an acquisition unit, to acquire input data comprising at least data relating to the airport and/or data relating to each aircraft intended to taxi or taxiing at the airport;
a planning step, performed by a computer, to generate from the input data a schedule that deterministically assigns a route for each of the one or more aircraft, the route of each aircraft defining a succession of predetermined transit zones on taxiways at the airport from an initial position of said aircraft to a final position of said aircraft, the route of each aircraft comprising associations between said transit zones and predetermined time slots, the schedule being generated so that each aircraft is intended to be exclusively situated in one of the transit zones during the time slot associated with said transit zone, the schedule being updated when at least one new input datum is acquired in the acquisition step;
a traffic management step, performed by an airport traffic management device, comprising at least the following sub-steps:
a tracking sub-step to track the current position of each aircraft taxiing at the airport; and
an authorization sub-step to generate, for each aircraft taxiing at the airport, an authorization to taxi to the next transit zone in which the schedule provides for the aircraft in question to be situated directly after the transit zone in which said aircraft is currently located if said next transit zone is available according to the schedule;
a transmission step, performed by a transmission unit, to transmit each authorization to taxi generated in the traffic management step to the aircraft for which said authorization was generated.

Thus, courtesy of the present invention, it is possible to obtain a schedule providing a precise transit zone during a precise time slot for each aircraft intended to taxi or taxiing at the airport, which allows smooth and efficient management and helps to optimize aircraft ground operations by avoiding, or at least minimizing, waiting times for aircraft authorization to taxi, thus allowing a not insignificant economic gain to be achieved, in particular in terms of the cost related to aircraft fuel consumption, but also by increasing the number of flights that can be offered for the airport.

Advantageously, the method comprises a monitoring step performed by the airport traffic management device continuously and automatically, the monitoring step comprising at least: - a detection sub-step to detect when at least one of the one or more aircraft operating at the airport is located in a transit zone other than the transit zone that the schedule provides for that aircraft at the current time; and - a transmission sub-step to transmit to the computer the current position of the one or more aircraft detected in the detection sub-step as new input data in the acquisition step.

In a preferred embodiment, at least the planning step is performed using artificial intelligence, said artificial intelligence being able to generate the schedule on the basis of the at least one input datum acquired in the acquisition step.

In addition, advantageously, the method comprises a training step, performed before the acquisition step, the planning step, the traffic management step and the transmission step, to train the artificial intelligence intended to perform the planning step, using training data that associate schedules and input data.

Moreover, advantageously, the schedule is generated so that the route assigned to each aircraft is a succession of transit zones that is intended to minimize at least one of the following criteria:
a taxiing time for the aircraft in question between the initial position of said aircraft and the final position of said aircraft;
a taxiing distance for the aircraft in question between the initial position of said aircraft and the final position of said aircraft;
an amount of fuel consumed for the aircraft in question to taxi between the initial position of said aircraft and the final position of said aircraft.

Furthermore, advantageously, the input data relating to each aircraft acquired in the acquisition step comprise, for each of the one or more aircraft intended to taxi or taxiing at the airport, at least one of the following data:
an arrival time slot for the aircraft in question at the airport;
a departure time slot for the aircraft in question at the airport;
a disembarkation time slot and a disembarkation gate that are reserved for the aircraft in question;
a boarding time slot and a boarding gate that are reserved for the aircraft in question;
characteristics of the aircraft in question; - predetermined constraints associated with the aircraft in question.

In addition, advantageously, the input data relating to the airport comprise at least one of the following data:
a digital map of the airport;
characteristic data pertaining to land vehicles intended to operate or operating at the airport;
weather forecast data;
alert data indicating that an incident is ongoing in an area of the airport.

In one particular embodiment, the digital map of the airport comprises the taxiways on the ground, said taxiways being divided into a succession of sections, each section being each of the predetermined transit zones, respectively, that may be part of a route assigned to one of the aircraft by the schedule.

In one particular embodiment, in the planning step, the schedule is generated by deterministically assigning a route for each of the one or more land vehicles.

The present invention also relates to an airport traffic management system for assisting in managing the taxiing of at least one aircraft at an airport.

According to the invention, the system comprises at least:
an acquisition unit configured to acquire input data comprising at least data relating to the airport and/or data relating to each aircraft intended to operate or operating at the airport;
a computer configured to generate from the input data a schedule that deterministically assigns a route for each of the one or more aircraft, the route of each aircraft defining a succession of predetermined transit zones on taxiways at the airport from an initial position of said aircraft to a final position of said aircraft, the route of each aircraft comprising associations between said transit zones and predetermined time slots, the schedule being generated so that each aircraft is intended to be exclusively situated in one of the transit zones during the time slot associated with that transit zone, the schedule being updated when at least one new input datum is acquired by the acquisition unit;
an airport traffic management device configured to:
track the current position of each aircraft taxiing at the airport; and
generate, for each aircraft taxiing at the airport, an authorization to taxi to the next transit zone in which the schedule provides for the aircraft in question to be situated directly after the transit zone in which said aircraft is currently located if said next transit zone is available according to the schedule;
a transmission unit configured to transmit each authorization to taxi generated by the airport traffic management device to the aircraft for which said authorization was generated.

### BRIEF DESCRIPTION OF THE DRAWINGS

The appended figures will make it easy to understand how the invention may be implemented. In these figures, identical reference signs denote similar elements.

FIG. 1 is a schematic view of an airport traffic management system according to a particular embodiment.

FIG. 2 is a digital map of an airport comprising taxiways divided into a succession of transit zones.

FIG. 3 is a block diagram of an airport traffic management method according to a particular embodiment.

### DETAILED DESCRIPTION OF THE PREFERRED EMBODIMENTS

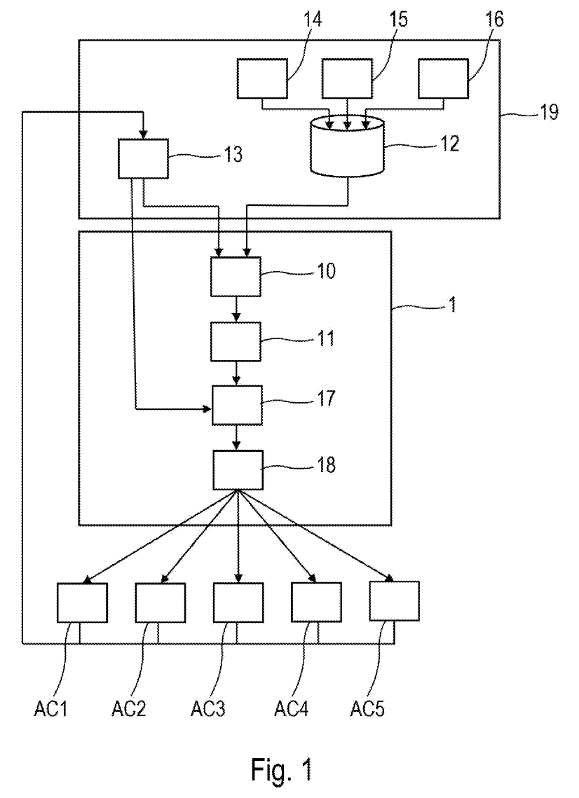

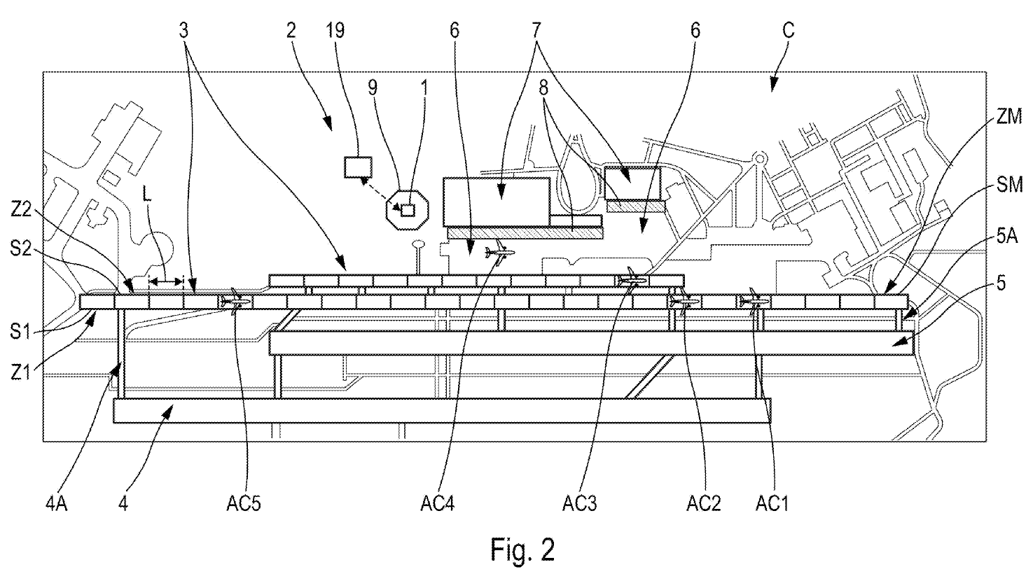

The airport traffic management system 1 (hereinafter system 1) schematically shown in FIG. 1 in a particular embodiment is a system for assisting in managing the taxiing of at least one aircraft, for example a passenger aircraft, at an airport 2 (FIG. 2). For the purposes of the present description, the system 1 is considered to be for managing the taxiing of a number N of aircraft denoted AC1 to ACN. The objective of the system 1 is to optimize ground operations that the aircraft AC1 to ACN need to perform at the airport 2 by accurately determining, in advance, each stage of taxiing for each of the aircraft AC1 to ACN as explained in detail below.

For the purposes of the present description, an aircraft's ground operations denote the stages of taxiing between an initial position of the aircraft at the airport 2 and a final position of the aircraft at the airport 2. More specifically, they are phases of taxiing on taxiways at the airport 2, namely lanes demarcated and arranged for aircraft movement on the ground at the airport 2 between runways and/or stands.

The airport 2 is shown schematically in a particular example in FIG. 2. In this example, the airport 2 has a relatively simple configuration intended to make it easy to understand the operation of the system 1. However, the airport 2 may have more complex configurations, in particular with a greater number of landing and take-off runways and a greater number of taxiways.

The airport 2 comprises taxiways 3 allowing the aircraft AC1 to ACN to taxi, in particular, between landing and take-off runways 4 and 5 and aprons 6. The aprons 6 are areas in which the aircraft AC1 to ACN are intended to park before reaching their next destination at the airport 2. By way of non-limiting example, the aprons 6 may be used for boarding or disembarking passengers and/or luggage, performing maintenance operations on the aircraft AC1 to ACN or holding some of the aircraft AC1 to ACN while waiting for them to be able to reach their next destination at the airport 2. The aprons 6 may in particular be adjacent to airport terminals 7 comprising boarding or disembarkation gates 8 shown schematically in FIG. 2 by hatched rectangles.

The airport 2 also comprises a control tower 9 comprising standard airport systems 19 for managing taxiing of the aircraft AC1 to ACN at the airport 2. Moreover, in one particular embodiment, shown in FIG. 2, the control tower 9 comprises the system 1. However, in other embodiments, depending on the configuration of the airport 2, the system 1 may be included elsewhere at the airport 2.

In addition, aircraft AC1, AC2, AC3, AC4 and AC5 are shown at the airport 2 in FIG. 2. These are aircraft that are included among the aircraft AC1 to ACN and currently operating at the airport 2. The aircraft AC1, AC2 and AC3 are aircraft using the taxiways 3 to get to the runway 5 to take off. The aircraft AC4 is an aircraft currently parked on one of the aprons 6 at the airport 2. The aircraft AC5 is an aircraft that has landed on the runway 4 and is using the taxiways 3 to get to the aprons 6. The other aircraft, namely the aircraft AC6 to ACN, are aircraft that are intended to operate at the airport 2 at a later date.

The system 1 is configured to acquire information from airport systems 19 at the airport 2 (as shown schematically by an arrow in FIG. 2) and, where applicable, from the aircraft AC1 to ACN that are intended to operate or are operating at the airport 2 in order to establish a schedule defining a precise route for each of said aircraft AC1 to ACN.

To that end, as shown schematically in FIG. 1 in one particular embodiment, the system 1 comprises an acquisition unit 10 configured to acquire input data. These input data comprise at least data relating to the airport 2, data relating to the aircraft AC6 to ACN that are intended to operate at the airport 2 and, where applicable, data relating to the aircraft AC1 to AC5 that are operating at the airport 2.

The acquisition unit 10 is configured to be able to acquire data continuously and automatically. In other words, the acquisition unit 10 is capable of acquiring new input data at any time during the operation of the system 1.

The input data relating to the airport 2 are information about the airport 2 such as the configuration of its taxiways 3, the configuration of its landing and take-off runways 4 and 5, the configuration of its aprons 6 or the configuration of its boarding and disembarkation gates 8. The input data relating to the aircraft that are intended to operate at the airport 2 are information on the aircraft AC6 to ACN, i.e., the aircraft for which a reservation has been made by the airline of said aircraft. Such a reservation includes in particular at least one embarkation and/or disembarkation gate 8, each associated with a time slot for the aircraft in question. The input data relating to the aircraft operating at the airport 2 are information on the aircraft AC1 to AC5, that is to say the aircraft currently taxiing on the taxiways 3 at the airport 2 or currently parking on one of the aprons 6.

Furthermore, the system 1 comprises a computer 11 configured to generate a schedule from the input data acquired by the acquisition unit 10. This is a schedule that deterministically assigns a route for each of the aircraft AC1 to ACN that is intended to operate at the airport 2 or is operating at the airport 2.

The route assigned to each of the aircraft AC1 to ACN defines a succession of predetermined transit zones Z1 to ZM on the taxiways 3 at the airport 2 for each of said aircraft AC1 to ACN. M is a positive integer that is the number of transit zones. This is because the taxiways 3 at the airport 2 can be divided into a succession of M sections S1 to SM, each being one of the transit zones Z1 to ZM, respectively. As shown in FIG. 2, this succession of sections S1 to SM may be a succession of rectangles. Preferably, all the taxiways 3 are divided into sections of the same length. However, in other embodiments, the sections S1 to SM may have lengths and/or shapes that vary from one section to another.

Thus, the route of an aircraft defines a path on the taxiways 3 for said aircraft, from transit zone to transit zone from an initial position of the aircraft at the airport 2 to a final position of the aircraft at the airport 2. The initial position of an aircraft may be its first position on the taxiways 3 when it arrives at the airport 2 and its final position may be its last position on the taxiways 3 when it departs from the airport 2.

For example, for an aircraft intended to arrive at the airport 2 by landing on the runway 4 and to depart again by taking off from the runway 5, the initial position of this aircraft may be the very first transit zone Z1 after an exit lane 4A from the runway 4 and its final position may be the very last transit zone ZM before an entry lane 5A to the runway 5. The route assigned to this aircraft by the schedule defines a series of very precise transit zones from the transit zone Z1 to the transit zone ZM which the aircraft is intended to use one after the other, in the order intended by the schedule, in order to perform all the ground operations that the aircraft is expected to perform at the airport 2 from when it lands to when it takes off.

In addition, the route assigned by the schedule to each of the aircraft AC1 to ACN comprises associations between the transit zones Z1 to ZM and predetermined time slots. Each predetermined time slot is a time window during which the aircraft in question may be situated in the transit zone associated with said time slot. Thus, the route assigned to each aircraft defines not only which succession of transit zones Z1 to ZM each of the aircraft AC1 to ACN is intended to use but also at what time each of the aircraft AC1 to ACN may be situated in each of said transit zones Z1 to ZM.

Moreover, the computer 11 is configured to generate a schedule which assigns a route to each of the aircraft AC1 to ACN deterministically. For the purposes of the present description, a deterministic assignment method should be understood in contrast to a probabilistic assignment method. In other words, the schedule is generated in such a way as to provide, for each of the aircraft AC1 to ACN intended to operate or operating at the airport 2, a transit zone Z1 to ZM which is reserved exclusively for said aircraft during a very specific time slot. Thus, each of said aircraft AC1 to ACN is intended to be exclusively situated in one of the transit zones Z1 to ZM during the time slot associated with that transit zone according to the schedule. It is therefore impossible for the same transit zone to be assigned by the schedule to multiple aircraft AC1 to ACN during the same time slot.

In one particular embodiment, the computer 11 is configured to generate a schedule providing for a safety distance between each of the aircraft AC1 to ACN. For example, there may be provision to always leave a vacant transit zone between two of the successive aircraft AC1 to ACN intended to taxi on the same taxiway 3.

Furthermore, the computer 11 is configured to update the schedule when at least one new input datum is acquired by the acquisition unit 10, as explained below.

In a preferred embodiment, the computer 11 is configured to generate a schedule so that the route assigned to each of the aircraft AC1 to ACN that is intended to operate or is operating at the airport 2 is a succession of transit zones Z1 to ZM that is intended to minimize at least one of the following criteria:
a taxiing time for the aircraft in question between the initial position of said aircraft and the final position of said aircraft at the airport 2;
a taxiing distance for the aircraft in question between the initial position of said aircraft and the final position of said aircraft at the airport 2;
an amount of fuel consumed for the aircraft in question to taxi between the initial position of said aircraft and the final position of said aircraft at the airport 2.

Thus, the system 1 optimizes the taxiing of the aircraft AC1 to ACN on the taxiways 3 at the airport 2 in terms of economic cost. This is because minimizing the taxiing time of the aircraft AC1 to ACN at the airport 2 optimizes the total number of aircraft that can be taxied at the airport 2 and thus the total number of flights offered by the airport 2. Similarly, minimizing the taxiing distance of the aircraft AC1 to ACN at the airport 2 or the amount of fuel consumed by said aircraft AC1 to ACN during their ground operations at the airport 2 allows the total fuel consumption of the aircraft AC1 to ACN to be limited, which results in an economic gain.

In one particular embodiment, the input data relating to each of the aircraft AC1 to ACN acquired by the acquisition unit 10, which allow the computer 11 to generate the schedule, comprise, for each of the aircraft AC1 to ACN, at least one of the following data:
an arrival time slot for the aircraft in question at the airport 2;
a departure time slot for the aircraft in question at the airport 2;
a disembarkation time slot and a disembarkation gate 8 that are reserved for the aircraft in question;
a boarding time slot and a boarding gate 8 that are reserved for the aircraft in question;
characteristics of the aircraft in question;
predetermined constraints associated with the aircraft in question.

The arrival of an aircraft at the airport 2 may be the landing of said aircraft on one of the runways 4 and 5 and the departure of an aircraft from the airport 2 may be take-off of said aircraft from one of the runways 4 and 5.

The boarding and disembarkation time slots and the boarding and disembarkation gates are reserved beforehand by airlines for their aircraft. These reservations may be made several months or more than a year in advance.

In addition, by way of non-limiting example, the characteristics of an aircraft may include: aircraft type, aircraft dimensions, aircraft mass, average taxiing speed, current position and/or current speed of the aircraft.

Furthermore, the predetermined constraints associated with an aircraft may be constraints related to requirements of the airline of said aircraft.

In one particular embodiment, the input data relating to the airport 2 acquired by the acquisition unit 10 comprise at least one of the following data:
a digital map C of the airport 2;
characteristic data pertaining to land vehicles intended to operate or operating at the airport 2;
weather forecast data;
alert data indicating that an incident is affecting at least one area of the airport 2.

The digital map C (FIG. 2) of the airport 2 is a map showing the taxiways 3 at the airport 2 which are divided into a succession of sections S1 to SM. Each of the sections S1 to SM is one of the predetermined transit zones Z1 to ZM that may be part of a route assigned to one of the aircraft AC1 to ACN by the schedule. The digital map C may include many other data relating to the configuration of the airport 2. The digital map C is provided beforehand and stored in a database of the airport 2 that is accessible to the system 1. The map C is able to be updated if necessary.

In one particular embodiment, shown in FIG. 2, the taxiways 3 at the airport 2 are divided in the digital map C into sections S1 to SM that each have a length L of between 70 m and 90 m. Preferably, the taxiways 3 are divided into sections that each have a length L of 80 m. This size is the average maximum length of the aircraft that are intended to operate at the airport 2. Thus, the transit zones may have a size suited to accommodating a single aircraft.

Furthermore, the land vehicles (not shown) may be all vehicles, other than the aircraft AC1 to ACN, that are intended to operate on the taxiways 3 in order to perform operations at the airport 2. For example, they may be traction vehicles for assisting the aircraft AC1 to ACN in taxiing, tanker vehicles or passenger and/or luggage vehicles. The characteristic data pertaining to the land vehicles may include data such as the vehicle type, the operations that the vehicle needs to perform or the current position and/or speed of the vehicle.

The alert data, on the other hand, may be data relating to an incident taking place at the airport 2, such as the presence of an obstacle on one of the taxiways 3. They may also be a distress signal from one of the aircraft AC1 to ACN intended to operate or operating at the airport 2 following an incident such as a breakdown. Depending on the type of distress signal, the computer 11 may be configured to update the schedule in order to direct the aircraft in distress to a suitable area by updating the route assigned to said aircraft. In this case, the routes of the other aircraft AC1 to ACN are also updated to reflect changes in the route of the aircraft in distress.

The alert data may in particular include data indicating which transit zones are unavailable (that is to say blocked to traffic) as a result of the incident. As explained below, the system 1 is configured not to authorize an aircraft to taxi toward an unavailable transit zone.

All the input data are able to be supplied to the system 1 by systems of the airport 2 that are included among the airport systems 19. In the particular embodiment in FIG. 1, the input data are supplied to the acquisition unit 10 by a database 12 of the airport 2 and a tracking system 13 of the aircraft AC1 to ACN.

The database 12 may comprise servers of the airport 2 that store data relating to the airport 2 and data relating to the aircraft AC1 to ACN that are intended to operate or are operating at the airport 2. For example, the database 12 may be fed with data from a reservation management system 14 that brings together the reservations made by airlines for their aircraft. The database 12 may also be fed with data from other systems of the airport 2 such as, by way of non-limiting example, a weather monitoring station 15 and an incident monitoring system 16.

Moreover, depending on the embodiment in question, at least some characteristic data pertaining to the aircraft AC1 to ACN that are intended to operate or are operating at the airport 2 may be acquired by the acquisition unit 10 directly from the aircraft AC1 to ACN or via the tracking system 13. This is because the tracking system 13 may be equipped with a radar that is able to detect the current position of some of said aircraft AC1 to ACN. However, the aircraft AC1 to ACN may also comprise devices such as transponders that allow them to identify themselves and communicate their current position directly to the system 1. Thus, it is conceivable for the aircraft AC1 to ACN to communicate their current position directly to the system 1.

Furthermore, as shown in FIG. 1, the system 1 comprises an airport traffic management device 17 (hereinafter device 17) configured to authorize the aircraft AC1 to AC5 to taxi at the airport 2 on the basis of the schedule generated by the computer 11. More precisely, the device 17 is configured to generate, for each of the aircraft AC1 to AC5 taxiing at the airport 2, an authorization to taxi to the next transit zone in which the schedule provides for the aircraft in question to be situated directly after the transit zone in which said aircraft is currently located if said next transit zone is available according to the schedule. In other words, the device 17 authorizes an aircraft to taxi only if the transit zone in which said aircraft is preparing to proceed by following the route assigned to it by the schedule is available.

A transit zone is said here to be available when said transit zone is not blocked to traffic. A transit zone is blocked to traffic if at least one condition defined beforehand during the configuration of the system 1 is met. Thus, a transit zone may be blocked to traffic, for example, if an aircraft is already situated in said transit zone, if an incident is affecting said transit zone or if an aircraft is situated in the transit zone directly after said transit zone (condition allowing a vacant transit zone to be observed between two successive aircraft).

To determine whether an authorization can be generated, the device 17 is configured to track the current position of each of the aircraft AC1 to AC5 taxiing at the airport 2. Based on the current position of an aircraft and by consulting the schedule generated by the computer 11, the device 17 is able to determine the transit zone in which said aircraft is currently situated and the next transit zone according to the schedule. If this next transit zone is available, that is to say if it is not blocked to traffic, for example by another aircraft or by some incident, then the device 17 generates an authorization to taxi for this aircraft.

In addition, the system 1 comprises a transmission unit 18 configured to transmit each authorization to taxi generated by the device 17 to the aircraft for which said authorization was generated. When one of the aircraft AC1 to AC5 receives an authorization to taxi, it may continue its journey on the taxiways 3 by proceeding toward the next transit zone that the schedule provides for it. Until an aircraft has received an authorization to taxi from the system 1, it cannot continue its journey on the taxiways 3 at the airport 2.

The system 1 is configured so that the device 17 generates the authorizations to taxi for all the aircraft AC1 to AC5 operating at the airport 2 continuously and automatically while the next transit zone (according to the schedule) for the aircraft in question is available. Thus, the taxiing of the aircraft AC1 to AC5 can be managed smoothly and efficiently.

In one particular embodiment, the device 17 is configured, in addition, to monitor the aircraft AC1 to AC5 that are operating at the airport 2 to check whether each of the aircraft AC1 to AC5 is situated in the transit zone in which the schedule provides for it to be situated. To that end, the device 17 is configured to detect when at least one of the one or more aircraft AC1 to AC5 operating at the airport 2 is located in a transit zone other than the transit zone that the schedule provides for that aircraft at the current time. When such an aircraft is detected by the device 17, said device 17 is configured to transmit the current position of the detected aircraft as a new input datum to the acquisition unit 10. In this case, the computer 11 updates the schedule taking into account this new input datum. More particularly, the computer 11 makes a first change to correct the route of the detected aircraft and then, if necessary, a second change to correct the routes of the other aircraft AC1 to ACN in the schedule on the basis of the first change.

In a preferred embodiment, the system 1 manages the taxiing of the aircraft AC1 to ACN using artificial intelligence. More precisely, at least the generation of the schedule by the computer 11 is carried out using artificial intelligence, and more particularly the updating of the schedule taking into account the new input data intended to be acquired over time by the acquisition unit 10.

To that end, the artificial intelligence is trained beforehand using training data. The training data are associations between schedules and input data. In particular, when training the artificial intelligence to update the schedule, the training data may comprise associations between updated schedules and predetermined events that may affect the airport 2 and/or the aircraft AC1 to ACN that are intended to taxi or are taxiing at the airport 2. The predetermined events are chosen so as to allow the artificial intelligence to react to any input datum that may be acquired by the acquisition unit 10. Thus, courtesy of these training data, the artificial intelligence is capable of learning how to change the schedule when one or other of the events chosen to develop said training data occurs.

By way of non-limiting example, the artificial intelligence can be trained to learn, for example, how to adapt the routes of the aircraft AC1 to ACN that are intended to taxi or are taxiing at the airport 2 when one of said aircraft AC1 to ACN is delayed or transmits a certain type of distress signal, when weather data predicting strong winds are acquired, or when a reservation change is made by an airline for at least one of the aircraft AC1 to ACN. In particular, the training data are chosen so that the artificial intelligence can learn to determine, where applicable, which events involve at least one of the transit zones Z1 to ZM being unavailable. The artificial intelligence can also be trained to predict the length of time for which a transit zone is unavailable on the basis of the event that caused said unavailability.

Furthermore, the artificial intelligence can also be configured to perform other tasks. For example, the artificial intelligence can be configured to directly and automatically contact a particular service when a particular type of event occurs. In the case of an accident, for example, it is conceivable for the artificial intelligence to autonomously contact the emergency services, such as firefighters.

In one particular embodiment, the computer 11 is configured to include at least one land vehicle in the schedule. More precisely, the computer 11 is configured to generate a schedule that deterministically assigns a route for each of the one or more land vehicles. The deterministic assignment method used to assign a route to each of the one or more land vehicles is similar to that used for the aircraft AC1 to ACN.

Thus, all the vehicles (the aircraft AC1 to ACN and the land vehicles) that may operate on the taxiways 3 at the airport 2 have a route defined by the schedule. This further improves the efficiency and flow of traffic on the taxiways 3 at the airport 2.

Thus, courtesy of the system 1 as described above, it is possible to obtain a schedule providing a precise transit zone during a precise time slot for each of the aircraft AC1 to ACN that is intended to taxi or is taxiing at the airport 2. This allows for the smooth and efficient management of the taxiing of the aircraft AC1 to ACN on the taxiways 3 at the airport 2 by way of the continuous and automatic generation and transmission of authorizations to taxi for each of the aircraft AC1 to ACN operating at the airport 2. This optimizes the ground operations of the aircraft AC1 to ACN by avoiding, or at least minimizing, the latency periods during which aircraft AC1 to ACN are forced to wait for an authorization to taxi while conditions for taxiing are met. Consequently, the system 1 allows a not insignificant economic gain to be achieved, in particular in terms of the cost related to the fuel consumption of the aircraft AC1 to ACN while they are taxiing on the taxiways 3 at the airport 2, but also by increasing the number of flights that can be offered for the airport 2.

Furthermore, the system 1 also ensures a high level of safety on the taxiways 3 at the airport 2. This is because the schedule generated by the computer 11 deterministically, where applicable using artificial intelligence, predicts the position of each of said aircraft AC1 to ACN at the airport 2 in advance and exclusively. This ensures that a well-defined position is assigned to each of the aircraft AC1 to ACN at all times and thus makes taxiing on the taxiways 3 at the airport 2 particularly safe.

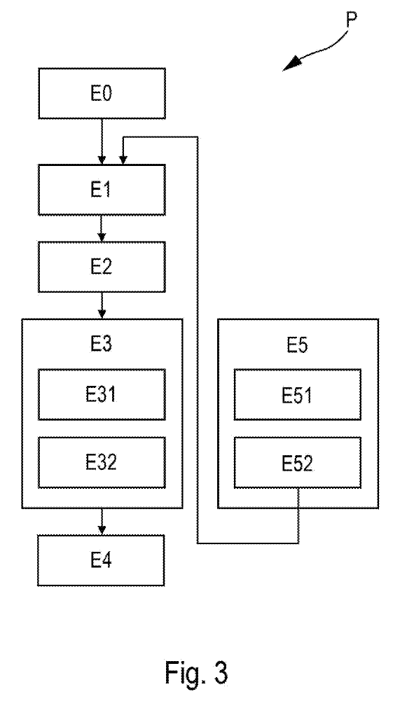

The system 1 as described above is suited to carrying out a method P for managing the taxiing of at least one aircraft at the airport 2. As shown in FIG. 3 in a particular embodiment, the method P comprises an acquisition step E1, a planning step E2, a traffic management step E3 and a transmission step E4. Steps E1, E2, E3 and E4 are performed continuously and automatically.

Step E1 is performed by the acquisition unit 10 to acquire the input data comprising at least data relating to the airport 2 and/or data relating to each of the aircraft AC1 to ACN intended to taxi or taxiing at the airport 2.

Step E2 is performed by the computer 11 to generate, from the input data, the schedule that deterministically assigns a route for each of the aircraft AC1 to ACN intended to operate or operating at the airport 2, as detailed above.

Step E3 is performed by the device 17 to: - track the current position of each of the aircraft AC1 to AC5 taxiing at the airport 2; and - generate, for each of the aircraft AC1 to AC5 taxiing at the airport 2, an authorization to taxi to the next transit zone in which the schedule provides for the aircraft in question to be situated directly after the transit zone in which said aircraft is currently located if said next transit zone is available according to the schedule.

Step E4 is performed by the transmission unit 18 to transmit each authorization to taxi generated by the device 17 to the aircraft for which said authorization was generated.

In one particular embodiment, shown in FIG. 3, the method P comprises a monitoring step E5 performed continuously and automatically by the device 17. Step E5 comprises at least: - a detection sub-step E51 to detect when at least one of the aircraft AC1 to AC5 operating at the airport 2 is located in a transit zone other than the transit zone that the schedule provides for that aircraft at the current time; and - a transmission sub-step E52 to transmit the current position of the one or more aircraft detected in sub-step E51 as new input data in step E1.

In one particular embodiment, shown in FIG. 3, the method P comprises a training step E0, performed before steps E1, E2, E3 and E4, to train the artificial intelligence intended to perform step E2. The artificial intelligence is trained using training data that associate updated schedules and predetermined events that may affect the airport 2 and/or the aircraft AC1 to ACN that are intended to taxi or are taxiing at the airport 2.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. An airport traffic management method for assisting in managing the taxiing of at least one aircraft at an airport, the method comprising the following sequence of steps, performed continuously and automatically:
an acquisition step, performed by an acquisition unit, to acquire input data comprising at least data relating to the airport and/or data relating to each aircraft intended to taxi or taxiing at the airport;-a planning step, performed by a computer, to generate from the input data a schedule that deterministically assigns a route for each of the one or more aircraft, the route of each aircraft defining a succession of predetermined transit zones on taxiways at the airport from an initial position of said aircraft to a final position of said aircraft, the route of each aircraft comprising associations between said transit zones and predetermined time slots, the schedule being generated so that each aircraft is intended to be exclusively situated in one of the transit during the time slot associated with said transit zone, the schedule being updated when at least one new input datum is acquired in the acquisition step;-a traffic management step, performed by an airport traffic management device, comprising at least the following sub-steps:-a tracking sub-step to track the current position of each aircraft taxiing at the airport; andan authorization sub-step to generate, for each aircraft taxiing at the airport, an authorization to taxi to the next transit zone in which the schedule provides for the aircraft in question to be situated directly after the transit zone in which said aircraft is currently located if said next transit zone is available according to the schedule;a transmission step, performed by a transmission unit, to transmit each authorization to taxi generated in the traffic management step to the aircraft for which said authorization was generated.-

2. The method according to claim 1 further comprising a monitoring step performed by the airport traffic management device continuously and automatically, the monitoring step comprising at least:
a detection sub-step to detect when at least one of the one or more aircraft operating at the airport is located in a transit zone other than the transit zone that the schedule provides for that aircraft at the current time; and-a transmission sub-step to transmit to the computer the current position of the one or more aircraft detected in the detection sub-step as new input data in the acquisition step.-

3. The method according to claim 2, wherein at least the planning step is performed using artificial intelligence, said artificial intelligence being able to generate the schedule on the basis of the at least one input datum acquired in the acquisition step.

4. The method according to claim 3, further comprising a training step, performed before the acquisition step, the planning step, the traffic management step and the transmission step, to train the artificial intelligence intended to perform the planning step, using training data that associate schedules and the input data.

5. The method according to claim 1, wherein the schedule is generated so that the route assigned to each aircraft is a succession of transit zones that is intended to minimize at least one of the following criteria:
a taxiing time for the aircraft in question between the initial position of said aircraft and the final position of said aircraft;-a taxiing distance for the aircraft in question between the initial position of said aircraft and the final position of said aircraft;-an amount of fuel consumed for the aircraft in question to taxi between the initial position of said aircraft and the final position of said aircraft.-

6. The method according to claim 1, wherein the input data relating to each aircraft acquired in the acquisition step comprise, for each of the one or more aircraft intended to taxi or taxiing at the airport, at least one of the following data:
an arrival time slot for the aircraft in question at the airport;-a departure time slot for the aircraft in question at the airport;-a disembarkation time slot and a disembarkation gate that are reserved for the aircraft in question;-a boarding time slot and a boarding gate that are reserved for the aircraft in question;-characteristics of the aircraft in question;-predetermined constraints associated with the aircraft in question.-

7. The method according to claim 1, wherein the input data relating to the airport comprise at least one of the following data:
a digital map of the airport;-characteristic data pertaining to land vehicles intended to operate or operating at the airport;-weather forecast data;-alert data indicating that an incident is ongoing in an area of the airport.-

8. The method according to claim 7, wherein the digital map of the airport comprises the taxiways on the ground, said taxiways being divided into a succession of sections, each section being each of the predetermined transit zones, respectively, that may be part of a route assigned to one of the aircraft by the schedule.

9. The method according to claim 8, wherein in the planning step, the schedule is generated by deterministically assigning a route for each of the one or more land vehicles.

10. An airport traffic management system for assisting in managing the taxiing of at least one aircraft at an airport comprising:
an acquisition unit configured to acquire input data comprising at least data relating to the airport and/or data relating to each aircraft intended to operate or operating at the airport;-a computer configured to generate from the input data a schedule that deterministically assigns a route for each of the one or more aircraft, the route of each aircraft defining a succession of predetermined transit zones on taxiways at the airport from an initial position of said aircraft to a final position of said aircraft, the route of each aircraft comprising associations between said transit zones and predetermined time slots, the schedule being generated so that each aircraft is intended to be exclusively situated in one of the transit zones during the time slot associated with that transit zone, the schedule being updated when at least one new input datum is acquired by the acquisition unit;-an airport traffic management device configured to:-track the current position of each aircraft taxiing at the airport; andgenerate, for each aircraft taxiing at the airport, an authorization to taxi to the next transit zone in which the schedule provides for the aircraft in question to be situated directly after the transit zone in which said aircraft is currently located if said next transit zone is available according to the schedule;a transmission unit configured to transmit each authorization to taxi generated by the airport traffic management device to the aircraft for which said authorization was generated.-
